(19) United States
(12) Patent Application Publication
(10) Pub. No.: US 2011/0058146 A1
(43) Pub. Date: Mar. 10, 2011

(54) PICO PROJECTOR APPARATUS

(75) Inventors: Ming-Kuen Lin, Yunlin County (TW); Tsung Hsun Wu, Taoyuan County (TW)

(73) Assignee: QISDA CORPORATION, Taoyuan (TW)

(21) Appl. No.: 12/876,177

(22) Filed: Sep. 6, 2010

(30) Foreign Application Priority Data
Sep. 7, 2009 (TW) 098129985

(51) Int. Cl. G03B 21/28

(52) U.S. Cl. 353/81

(57) ABSTRACT

The invention discloses a projector apparatus for projecting an image onto a surface, comprising a light source module for generating a single first light path; a light beam homogenizer for inputting first light path to perform beam homogenization over the first light path; an illumination lens set for inputting the homogenized first light path and re-directing the first light path to a second light path, the first light path and the second light path forming an positive angle; a reflection-type image generator for generating said image; a prism set for inputting said second light path and outputting the second light path onto the reflection-type image generator, wherein the reflection-type image generator reflects the second light path and forming a third light path carrying said image, the third light path being reflected by said prism set to forming a fourth light path; an image projection lens set disposed on the fourth light path for projecting said image onto the surface.

### CROSS-REFERENCE TO RELATED APPLICATION

This utility application claims priority to Taiwan application serial number 098129985, filed Sep. 7, 2009, which is incorporated herein by reference.

### BACKGROUND OF THE INVENTION

1. Field of the Invention

This present invention relates to a projector apparatus, and relates to the pico projector apparatus, and particularly relates to the light path arrangement of pico projector apparatus.

2. Description of the Prior Art

Nowadays, the projector apparatus has extended its presence in the original business community into the household market or the portable mobile market. In the application of portable mobile market, the volume or size of projector apparatus is a major issue. In particular, reducing the thickness (i.e., height) of light source module and projecting module is the main goal the producers intend to achieve.

In the state of arts, the light source module employing LED typically implements the dichroic combiner to form a single light path, which does not effectively reduce the size of light source module. In addition, the light beam homogenizer typically takes the form of light pipe, the length of which is also the reason why the size of light source module can not reduce. Furthermore, while employing a typical prism set to illuminate light source to a reflection-type image generator also negatively make a larger size in height (i.e. thickness) direction of the projecting module.

Therefore, there is a strong need in the marketplace for a more miniaturized projector apparatus or module, that makes the projector apparatus portable or allows feasible implementation within other devices, such as mobile phone.

### SUMMARY OF THE INVENTION

Accordingly, one aspect of the invention is to provide a projector apparatus or module of miniaturized size.

Another aspect of the invention is to provide a pico projecting module to be used with a mobile phone module making a mobile phone embedded with the projector function possible.

Still another aspect of the invention is to provide a pico projecting module, wherein the light source may be implemented by a single light path design of LED light source.

The above objectives of the invention may be achieved by a retro total internal reflection telecentric optical configuration or by a total internal reflection telecentric optical configuration

Specifically, a retro total reflected telecentric optical configuration is provided comprising a prism set, wherein prism set comprising a first prism, the first prism including a main light inputting surface and a main light outputting surface, the main light inputting surface intersects with a vertical reference plane at a first angle, the main light outputting surface intersects with the vertical reference plane at a second angle, the first angle is about 28 (±3) degrees and the second angle is about 32 (±3) degrees. In one respect, this design can meet the need of the reflection-type image generator for irradiation (incidence) angle, and in another respect, this design can reduce the difference in height (thickness, i.e. in Y direction) direction between the prism set and the reflection-type image generator.

In other words, to accomplish the above mentioned objective, the pico projector apparatus of the invention, which projects an image onto a surface, comprises a light source module, for generating a single first light path; a light beam homogenizer, inputting the first light path, for performing uniformity effect over the light of first light path; an illumination lens set, inputting the first light path going through the uniformity effect, for redirecting the first light path to a second light path, the first light path and the second light path forming a positive angle; a reflection-type image generator for forming the image; a prism set, inputting the second light path, for projecting the second light path onto the reflection-type image generator, wherein, after reflecting the second light path, the reflection-type image generator forms a third light path including the image, and as the third light path is reflected by the prism set, a fourth light path is generated; an image projection lens set, disposed on the fourth light path, for projecting the image onto the surface.

Other than the first embodiment, the pico projector apparatus of second embodiment of the invention, which projecting an image onto a surface, comprises a light source module for generating a single first light path; a light beam homogenizer, inputting the first light path, for performing uniformity effect over the light of first light path; an illumination lens, inputting the first light path going through the uniformity effect, for further enhance the uniformity and illumination effect on the first light path; a reflection-type image generator forming the image; a prism set, inputting the first light path of enhanced uniformity and illumination effect, for totally reflecting the first light path forming a second light path to illuminate the reflection-type image generator, wherein, after the second light path is reflected, the reflection-type image generator forms a third light path including the image, the third light path passing through the prism set; an image projection lens set, disposed on the third light path, for projecting the image onto the surface.

The aspect of the present invention will no doubt become obvious to those of ordinary skill in the art after reading the following detailed description of the preferred embodiment, which is illustrated in the following figures and drawings.

### BRIEF DESCRIPTION OF THE APPENDED DRAWINGS

FIG. 1 shows the projector apparatus of first embodiment.

FIG. 2a shows the perspective view of the first prism of the first embodiment.

FIG. 2b shows the right side view of the first prism according to the first embodiment.

FIG. 2c shows the top view of the first prism according to the first embodiment.

FIG. 3 shows the projector apparatus of the second embodiment.

### DETAILED DESCRIPTION OF THE INVENTION

Some preferred embodiments and practical applications of this present invention would be explained in the following paragraph, describing the characteristics, spirit and advantages of the invention.

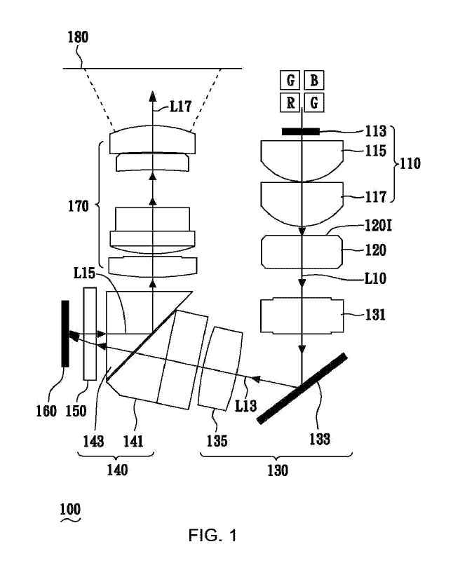

As shown in FIG. 1, the projector apparatus according to the preferred embodiment of the invention is utilized for projecting a image onto a surface, allowing people in front of the surface to view the content of the image. The projector apparatus might constitute a standalone projector, or might constitute a module which is a component of other portable device, e.g., a mobile phone, forming a portable combo machine, e.g., a mobile phone including the projector function.

In the following recitations, the so-called ┌light path┘ means the path on which the light (with or without image) traveling through and the light per se. The light per se might not include any information, or, due to some image processing operation, e.g., the light is reflected by the reflection-type image generator, might include the information to be projected and displayed. For easy understanding and readability for the figures in this specification, only the main light line on the light path in all figures is shown and other non-main light lines are not shown for brevity.

As shown in FIG. 1, except other components which already or will be in the market, the projector apparatus 100 of this invention comprises a light source module 110 for generating a single first light path L10; a light beam homogenizer 120, inputting the first light path L10, for performing uniformity effect on the light of first light path; an illumination lens set 130, inputting the first light path L10 going through the uniformity effect, for redirecting the first light path L10 to a second light path L13, the first light path L10 intersecting with the second light path L13 at a positive angle; a reflection-type image generator 160, for forming the image thereon; a prism set 140, after inputting the second light path L13, projecting the second light path L13 onto the reflection-type image generator 160, wherein, after the reflection-type image generator 160 reflects the second light path L13, forming a third light path L15 including the image, the third light path L15 is totally reflected by the prism set 140 for generating a fourth light path L17 including the image; an image projection lens set 170 disposed on the fourth light path L17, for projecting the mage of fourth light path L17 onto the surface 180.

Under the structure of FIG. 1, in some embodiments, the light source module 110 comprises an LED light source 113 ∘ And the LED light source 113 takes the form of RGGB directly forming the single first light path L10, as shown in FIG. 1. Or, in other embodiments not shown in the drawings, the LED light source separately employs the R light source, the G light source, the B light source, and then via a dichroic combiner, the light source module 110 forming the single first light path L10 by combining the R light source, G light source and B light source. For instance, the light-combination adopted by the U.S. patent application No. US 2006/0279710 A1, or the U.S. patent application No. US 2006/0164600 A1, or that adopted by the issued U.S. Pat. No. 6,644,814 B2. However, these approaches might result in larger size of projector apparatus.

Under the structure of FIG. 1, in some embodiments, the light source module 110 comprises a light source 113 and a light source distribution modulation module (115, 117), the light source distribution modulation module (115, 117) inputting the light produced by the light source 113 and outputting the first light path L10. With regard to distribution of the illumination angle, the first light path L10 emitting through the light source distribution modulation module (115, 117) has appropriate and evenly distribution, which is the main function of the light source distribution modulation module (115, 117). The preferred embodiments of light source distribution modulation module (115, 117) include the conventional collimator lens.

Under the structure of FIG. 1, in some embodiments, the light beam homogenizer 120 includes a pico lenslet array, the pico lenslet array forming a light inputting surface 1201, the light inputting surface 1201 is imaged on the reflection-type image generator 160. As known to persons skilled in this arts, the pico lenslet array includes multiples of pico lens on an same surface and each pico lens typically has identical focal length.

Under the structure of FIG. 1, in some embodiments, the curvature of radius of each pico lens within the pico lenslet array is about smaller than 2, thereby obtaining better light uniformity effect. As the first light path L10 leaves the light beam homogenizer 120, it irradiates the illumination lens set 130, which redirects the first light path L10 to a second light path L13, the first light path L10 intersects with the second light path L13 at a positive angle.

The illumination lens set 130 mainly includes the illumination lens 131, 135 and direction guidance 133 (including, but not limited to, the reflection mirror). As known to persons skilled in the arts, the illumination lens 131, 135 mainly function to perform evenness effect on the distribution of light source illumination intensity, and also minimize the unevenness of low illumination intensity of light source. The embodiment for illumination lens 131 or illumination lens 135 might use the conventional condenser lens, which makes the main light line parallel to the light axis of projector apparatus and minimizes the deviation. The direction guidance 133 functions to redirect the first light path L10 to a second light path L13.

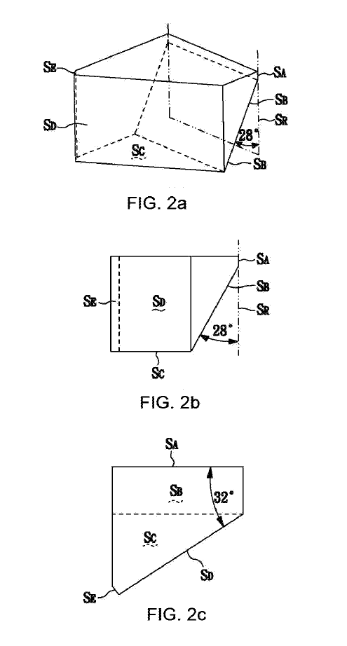

Under the structure of FIG. 1, in some embodiments, the prism set 140 includes a first prism 141, wherein the first prism 141 includes a main light inputting surface S_{B} and a main light outputting surface S_{D}, as shown in FIGS. 2a [symbol] 2b [symbol] 2c. The positive angle between the main light inputting surface S_{B} and a vertical reference plane S_{R} is a first angle, the positive angle between the main light outputting surface S_{D} and the vertical reference plane S_{R} is a second angle, the first angle is about 28 degree (±3 degree), and the second angle is about 32 degree (±3 degree), in order to meet the requirement of the reflection-type image generator 160 as to the light incidence angle. Under the structure of FIG. 1, in some embodiments, the prism set 140 includes a second prism 143, wherein the second prism 143 is a total internal reflection prism. Since the second light path L13 first penetrates the first prism 141, then the second light path L13 is reflected by the reflection-type image generator 160 obtaining the projection information reflected to form the third light path L15, the third light path L15 is then totally reflected by the second prism 140 to form the fourth light path L17, the configuration on which this prism set 140 is applied is therefore named as retro total internal reflection telecentric optical configuration.

As shown in the embodiment of FIGS. 2a [symbol] 2b [symbol] 2c for the first prism 141, the light enters through the inputting surface SB, outputs from the outputting surface SD, the disclosed design parameters of this first prism 141 (and/or the second prism 143) are only a preferred embodiment. Other different parameters, which also meet requirement of the reflection-type image generator 160 as to the light incidence angle, on one hand, and, on the other hand, might reduce the height (thickness, i.e., in Y direction) difference between the prism set 140 and the reflection-type image generator 160, might be chosen.

Looking back to FIG. 1, for some embodiments, the reflection-type image generator 160 includes a digital micromirrors device (DMD). A field lens 150 is typically arranged on the front side of the reflection-type image generator 160 which mainly functions to increase the viewing angle.

The third light path L15 including the projection information is totally reflected by the second prism 143 forming the fourth light path L17. This fourth light path L17 passes through the image projection lens set 170, and the information are projected onto the surface 180. The image projection lens set 170a typically includes multiple lens of various functions to achieve magnification and projection functions.

Due to the provision of embodiments shown in FIGS. 1 [symbol] FIG. 2a [symbol] FIG. 2b [symbol] FIG. 2c, the above invention objectives are achieved. Through simulations and experiments, as 0.22 inch DMD is used in configuration of the subject invention, the size of the projector apparatus can be lowered to 21.5 mm (X-lengthwise direction)*6.5 mm (Y-thickness direction)*20 mm (Z-widthwise direction), the total size is smaller than 3 cc, and still achieve level of 10 lm/W light efficiency.

The second embodiment is described hereinafter.

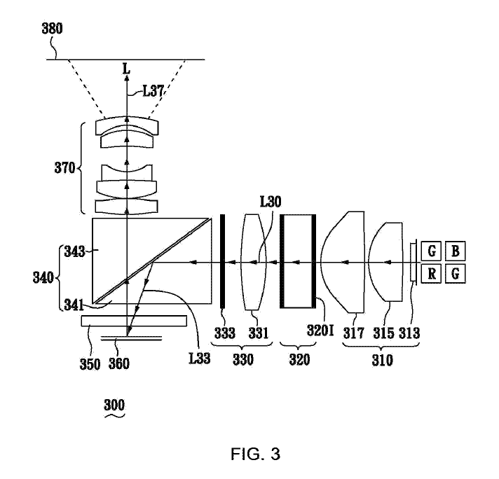

As shown in FIG. 3, except other components which already or will be in the projector apparatus market, the projector apparatus 300 of second embodiment includes a light source module 310 for generating a single first light path L30; a light beam homogenizer 320; an illumination lens 330; a reflection-type image generator 360; and an image projection lens set 370.

The light beam homogenizer 320 inputs the first light path L30 for performing uniformity effect over the first light path L30. The illumination lens 330 inputs the first light path L30 having been performed the uniformity effect, for further enhancing the uniformity and illumination effect over the first light path L30. The reflection-type image generator 360 is used to form the image, and the prism set 340 functions to input the first light path L30 of enhanced uniformity illumination effect. The first light path L30 is then totally reflected forming a second light path L33 illuminating reflection-type image generator 360, the first light path L30 and the second light path L33 forms a positive angle. The reflection-type image generator 360 reflects the second light path L33, forming a third light path L37 including the image, and the third light path L37 passes through the prism set 340. The image projection lens set 370 is disposed on the third light path L37 for projecting the image onto the surface 380.

Under the structure of FIG. 3, in some embodiments, the light source module 310 includes a LED light source 313. The LED light source 313 may take form of RGGB to directly form the single first light path L30, as shown in FIG. 1.

Or, in embodiments not shown in the drawings, the LED light source separately employs the R light source, the G light source, the B light source, and then via a dichroic combiner, the light source module 310 forming the single first light path L30 by combining the R light source, G light source and B light source. For instance, the light-combination adopted by the U.S. patent application No. US 2006/0279710 A1, or the U.S. patent application No. US 2006/0164600 A1, or that adopted by the issued U.S. Pat. No. 6,644,814 B2. However, these approaches might result in larger size of projector apparatus.

Under the structure of FIG. 3, in some embodiments, the light source module 310 includes a light source 313 and a light source distribution modulation module (315, 317), light source distribution modulation module (315, 317) inputting the light generated by the light source 313 and outputting the first light path L30. In regard to the distribution of illumination angle, the first light path L30 emitting from the light source distribution modulation module (315, 317) has appropriate and evenly distribution, which is the main function of the light source distribution modulation module (315, 317). The embodiments of light source distribution modulation module (315, 317) include the conventional collimator lens.

Under the structure of FIG. 3, in some embodiments, the light beam homogenizer 320 includes a pico lenslet array, the pico lenslet array forms a light inputting surface 3201 which is imaged on the reflection-type image generator 360.

Under the structure of FIG. 3, in some embodiments, the curvature of radius of each pico lens of the pico lenslet array is about smaller than 2 in order to a better uniformity effect.

As the first light path L30 leaves the light beam homogenizer 320, it irradiates the illumination lens set 330. The illumination lens set 330 mainly includes the illumination lens 331, 333. As known to persons skilled in the arts, the illumination lens 331, 333 mainly function to perform evenness effect on the distribution of light source illumination intensity, and also minimize the unevenness of low illumination intensity of light source. The embodiment for illumination lens 331 or illumination lens 333 might use the conventional condenser lens, which makes the main light line parallel to the light axis of projector apparatus and minimizes the deviation.

Under the structure of FIG. 3, in some embodiments, the prism set 340 includes a first prism 341, wherein first prism 341 includes a main light inputting surface S_{B a} and a main light outputting surface S_{D}, as shown in FIGS. 2a [symbol] 2b [symbol] 2c. The positive angle between the main light inputting surface S_{B} and a vertical reference plane S_{R} is a first angle, the positive angle between the main light outputting surface S_{D} and the vertical reference plane S_{R} is a second angle, the first angle is about 28 degree (±3 degree), and the second angle is about 32 degree (±3 degree), in order to meet the requirement of the reflection-type image generator 360 as to the light incidence angle. The first prism 341 functions as a total internal reflection prism. Since first light path L30 is first reflected by the first prism 341, then reflected by the reflection-type image generator 360 for obtaining the projection information to form the third light path L37, the configuration of this prism set 340 in FIG. 3 is therefore named as total internal reflection (TIR) telecentric optical configuration. However, the first prism 341 may implement other conventional type prisms that are different from that shown in FIGS. 2a [symbol] 2b [symbol] 2c.

The design parameters of first prism 341 (and/or second prism 343) mainly, on one hand, to meet requirement of illumination angle of the reflection-type image generator 360, and, on the other hand, to reduce the difference of height (thickness) (i.e., in Y direction) between the prism set 341 and the reflection-type image generator 360. Under the configuration of FIG. 3, in some embodiments, the reflection-type image generator 360 includes a digital micromirrors device (DMD). A field lens 350, which functions to increase the viewing angle, is typically provided on the front side of the reflection-type image generator 360.

The third light path L37 including the projection information is totally reflected by the prism set 340, and then it passes through image projection lens set 370, and the information are projected onto the surface 380. The image projection lens set 370a typically includes multiple lens of various functions to achieve magnification and projection functions.

Due to the provision of embodiments shown in FIGS. 3 [symbol] FIG. 2a [symbol] FIG. 2b [symbol] FIG. 2c, the above invention objectives are achieved. Through simulations and experiments, as 0.22 inch DMD is used in configuration of the subject invention, the size of the projector apparatus can be lowered to 21.5 mm (X-lengthwise direction)*6.5 mm (Y-thickness direction)*20 mm (Z-widthwise direction), the total size is smaller than 3 cc, and still achieve level of 10 lm/W light efficiency.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A projector apparatus for projecting an image onto a surface, comprising:
a light source module, for generating a single first light path;
a light beam homogenizer, inputting the first light path for performing uniformity effect over the light on the first light path;
an illumination lens set, for inputting the first light path being operated by the uniformity effect and re-directing the first light path to a second light path, the first light path forming a positive angle with respect to the second light path;
a reflection-type image generator for forming the image;
a prism set, inputting the second light path and projecting the second light path to the reflection-type image generator, wherein a third light path having the image is formed after the reflection-type image generator reflects the second light path, and a fourth light path is generated after the third light path is reflected by the prism set;
an image projection lens set, disposed on the fourth light path for projecting the image on to the surface.

2. The projector apparatus of claim 1, wherein the light source module comprises a LED light source.

3. The projector apparatus of claim 1, wherein the reflection-type image generator comprises a digital micromirrors device (DMD).

4. The projector apparatus of claim 1, wherein light source module comprises a light source and a light source distribution modulation module, the light source distribution modulation module inputting the light source and outputting the first light path having appropriate angular distribution.

5. The projector apparatus of claim 1, wherein the light beam homogenizer comprises a pico lenslet array, the pico lenslet array forming a light inputting surface, the light inputting surface is imaged on the reflection-type image generator.

6. The projector apparatus of claim 1, wherein the prism set comprises a first prism, wherein the first prism has a main light inputting surface and a main light outputting surface, the main light inputting surface intersects with a vertical reference plane at a first angle, the main light outputting surface intersects with the vertical reference plane at a second angle, the first angle is about 28 degrees and the second angle is about 32 degrees, for fulfilling a required illumination angle of the reflection-type image generator.

7. The projector apparatus of claim 1, wherein the pico lenslet array includes multiple of pico lens, the curvature of radius of each pico lens is about smaller than 2.

8. The projector apparatus of claim 2, wherein LED light source employs the arrangement of RGGB for forming the single first light path.

9. The projector apparatus of claim 1, wherein the prism set comprises a second prism, wherein the second prism is a total internal reflection (TIR) prism.

10. The projector apparatus of claim 3, wherein the DMD comprises multiples of lenslet unit, each lenslet unit, responsive to a control signal, rotates along an axis of vertical orientation or diagonal orientation.

11. The projector apparatus of claim 2, wherein LED light source employs R light source, G light source and B light source, the light source module forms the single first light path via a dichroic combiner inputting the R light source, G light source and B light source.

12. A projector apparatus for projecting an image onto a surface, comprising:
a light source module for generating a single first light path;
a light beam homogenizer, inputting the first light path for performing uniformity effect over the light on the first light path;
an illumination lens set, inputting the first light path being operated by the uniformity effect, for further enhancing uniformity effect and illumination effect of the first light path;
a reflection-type image generator for forming the image;
a prism set, inputting the first light path of enhanced uniformity and illumination effect, for totally-reflecting the first light path to form a second light path illuminating the reflection-type image generator, wherein the reflection-type image generator reflects the second light path and forms a third light path, having the image, passing through the prism set; an image projection lens set, disposed on the third light path for projecting the image on the surface.

13. A projector apparatus of claim 12, wherein light source module comprises a light source and a light source distribution modulation module, the light source distribution modulation module inputting the light source and outputting the first light path having appropriate angular distribution.

14. A projector apparatus of claim 12, wherein the light beam homogenizer comprises a pico lenslet array, the pico lenslet array forming a light inputting surface, the light inputting surface is imaged on the reflection-type image generator.

15. A projector apparatus of claim 12, wherein the pico lenslet array includes multiple of pico lens, the curvature of radius of each pico lens is about smaller than 2.

16. A projector apparatus of claim 12, wherein the light source employs the arrangement of RGGB of an LED light source for forming the single first light path.

17. A projector apparatus of claim 12, wherein the prism set comprising a first prism, wherein the first prism is a total internal reflection (TIR) prism.

18. A projector apparatus of claim 12, wherein the reflection-type image generator comprises multiples of lenslet unit, each lenslet unit, responsive to a control signal, rotates along an axis of vertical orientation or diagonal orientation.

19. A projector apparatus for projecting an image onto a surface, comprising:
a light source module for generating a single first light path;
a light beam homogenizer, inputting the first light path for performing uniformity effect over the light on the first light path;
an illumination lens set, for inputting the first light path being operated by the uniformity effect and re-directing the first light path to a second light path, the first light path forming a positive angle with respect to the second light path;
a reflection-type image generator for forming the image;
a prism set, inputting the second light path and projecting the second light path to the reflection-type image generator, wherein a third light path having the image is formed after the reflection-type image generator reflects the second light path, and a fourth light path is generated after the third light path is reflected by the prism set, wherein the prism set comprises a first prism, wherein the first prism has a main light inputting surface and a main light outputting surface, the main light inputting surface intersects with a vertical reference plane at a first angle, the main light outputting surface intersects with the vertical reference plane at a second angle, the first angle and the second angle are selected suitably for fulfilling a required illumination angle of the reflection-type image generator;
an image projection lens set, disposed on the fourth light path, for projecting the image onto the surface.

20. A projector apparatus for projecting an image onto a surface, comprising:
a light source module for generating a single first light path;
a light beam homogenizer, inputting the first light path for performing uniformity effect over the light on the first light path, wherein the light beam homogenizer comprises a pico lenslet array, the pico lenslet array forming a light inputting surface;
an illumination lens, inputting the first light path being operated by the uniformity effect, for further enhancing uniformity effect and illumination effect of the first light path;
a reflection-type image generator for forming the image, wherein the light inputting surface of the pico lenslet array is imaged on the reflection-type image generator;
a prism set, inputting the first light path of enhanced uniformity and illumination effect, for totaling-reflecting the first light path to form a second light path illuminating the reflection-type image generator, wherein the reflection-type image generator reflects the second light path and forms a third light path, having the image, passing through the prism set;
an image projection lens set, disposed on the third light path, for projecting the image onto the surface.
